(19) United States
(12) Patent Application Publication
(10) Pub. No.: US 2021/0158140 A1
(43) Pub. Date: May 27, 2021

(54) CUSTOMIZED MACHINE LEARNING DEMONSTRATIONS

(71) Applicant: International Business Machines Corporation, Armonk, NY (US)

(72) Inventors: LUKASZ G. CMIELOWSKI, KRAKOW (PL); Wojciech Sobala, KRAKOW (PL); MAKSYMILIAN ERAZMUS, Zasów (PL); RAFAL BIGAJ, KRAKOW (PL)

(21) Appl. No.: 16/691,698

(22) Filed: Nov. 22, 2019

(51) Int. Cl. G06N 3/08; G06N 3/04

(52) U.S. Cl. CPC G06N 3/08; G06N 3/04

(57) ABSTRACT

A target description is received. Based on the target description, a set of artificial data is generated. A machine learning zero model is trained using the set of artificial data. The machine learning zero model is deployed as a service. A set of demonstration data is processed, using the service, and a user is notified of the results.

### BACKGROUND

The present disclosure relates generally to the field of machine learning models, and more particularly to customizing machine learning models for demonstrations.

Machine learning models and neural networks are used with increasing frequency. Machine learning models may be used for a wide variety of applications, such as “reading” handwritten documents, making online shopping recommendations, generating dynamic navigation routes that take into account historical traffic density, etc. Machine learning models may ingest training data to customize the model for a particular purpose.

### SUMMARY

Embodiments of the present disclosure include a method, computer program product, and system for deploying a machine learning zero model.

A target description is received. Based on the target description, a set of artificial data is generated. A machine learning zero model is trained using the set of artificial data. The machine learning zero model is deployed as a service. A set of demonstration data is processed, using the service, and a user is notified of the results.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates an example computing environment, in accordance with embodiments of the present disclosure.

FIG. 2 illustrates a flowchart of a method for deploying a machine learning zero model, in accordance with embodiments of the present disclosure.

FIG. 3 illustrates an example neural network that may be specialized to implement a machine learning zero model, in accordance with embodiments of the present disclosure.

FIG. 4 depicts a cloud computing environment according to an embodiment of the present disclosure.

FIG. 5 depicts abstraction model layers according to an embodiment of the present disclosure.

FIG. 6 illustrates a high-level block diagram of an example computer system that may be used in implementing embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of machine learning models, and more particularly to customizing machine learning models for demonstrations. While the present disclosure is not necessarily limited to such applications, various aspects of the disclosure may be appreciated through a discussion of various examples using this context.

Machine learning models are increasingly used in many industries to identify trends, find correlations, make decisions, automate tasks, etc. While it may be possible to develop one's own machine learning model, it may be more desirable to engage a specialist or vendor to build the machine learning model.

Vendors may desire to demonstrate the capabilities of their technology and machine learning models to potential clients. However, traditional methods for training up a machine learning model for a client-specific purpose require a large amount of training data from the client. This training data may contain confidential information, proprietary information, etc., and so sharing this training data prior to a establishing a formal relationship (e.g., signing a contract) may raise reasonable concerns. Creating such a trained model may require a team of technical engineers/staff and may slow the negotiation process.

Described herein are embodiments for customizing machine learning model demonstrations without the need for a large set of training data. The client may supply a description of the goal, or target, they desire to accomplish using the machine learning model. For example, a client may wish to increase traffic/engagement with a particular website among a certain demographic. From this target description, categorical features may be identified and extracted. For example, the parameters of the target demographic, features/aspects of the website, etc. In some embodiments, categorical features may include a range of values.

Using the target description and its features, an artificial set of data may be generated. In some embodiments, this may include gathering additional data related to the target and its features. For example, if a target demographic includes college-educated males aged 30-45, census records, university records, employment records, etc. may be used to “learn” additional attributes/features that tend to be associated with that target demographic. In some embodiments, this may be facilitated using the target description itself. For example, an optimal datapoint may be created by using the target description to define the features/attributes of the optimal datapoint itself.

Using the target description and/or additional information, a robust set of artificial data may be generated. This may include a random or semi-random generation of datapoints for a set of training data. These random/semi-random datapoints may be controlled, or distributed, according to the trends identified according to the additional attributes/features. In this way, the set of artificial data may be generated to mimic an authentic set of data. In some embodiments, a dataset large enough to train a machine learning model may require over a thousand data points.

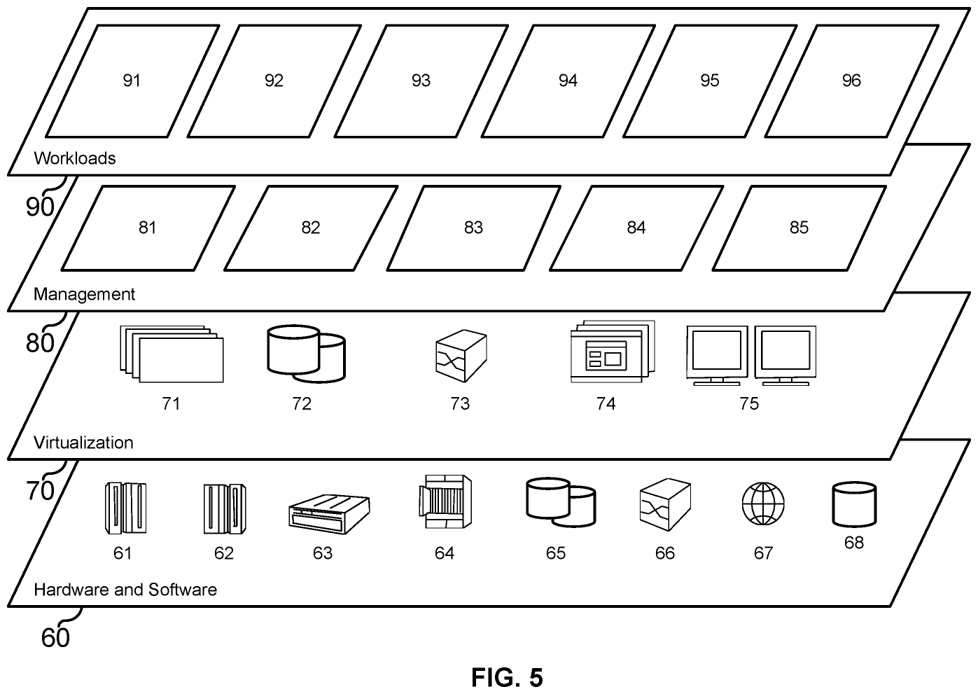

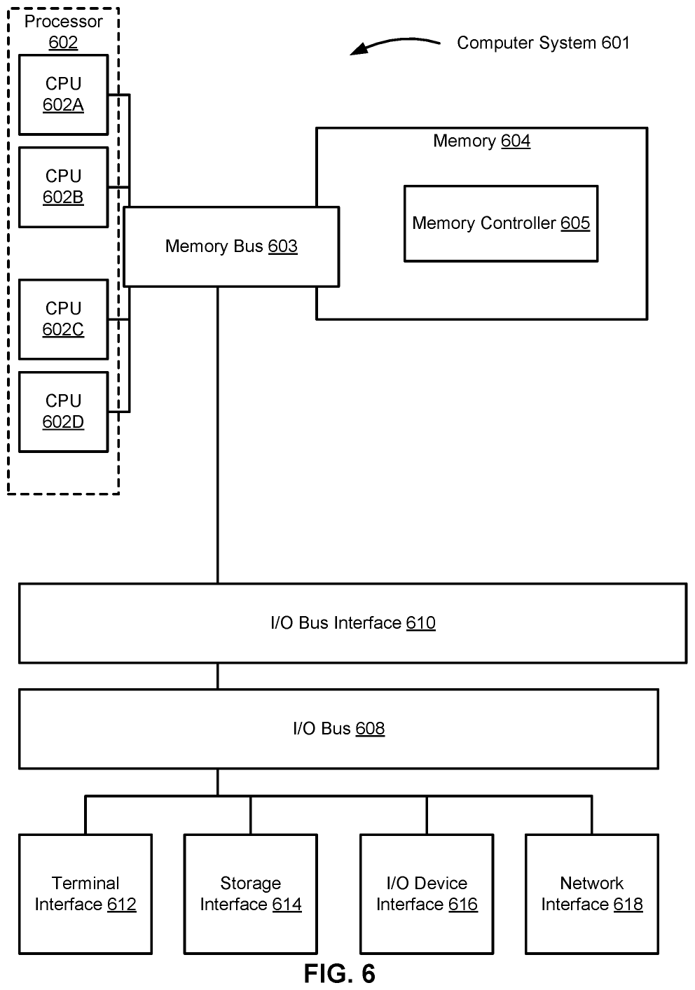

The artificial dataset may be ingested by a neural network of a machine learning model to train a “machine learning zero model” (e.g., a machine learning model trained with no authentic/real/true data). Once trained, the machine learning zero model may be deployed or otherwise made available to the client using a web service. Additional detail regarding cloud computing and software as a service is given with regard to FIGS. 5 and 6.

In this way, a client may conduct a demonstration or test of the machine learning zero model using a set of authentic data or a set of demonstration data to obtain a set of demonstration results so that the client may evaluate the quality of the offered machine learning model without divulging any proprietary, confidential, or sensitive data to the vendor.

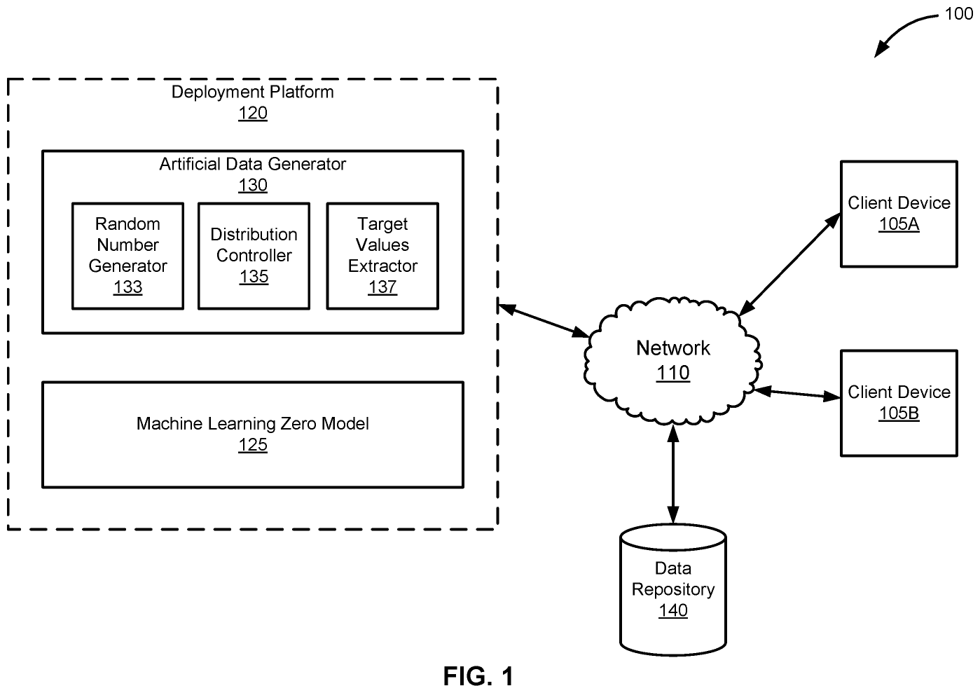

Referring now to FIG. 1, illustrated is an example computing environment 100, in accordance with embodiments of the present disclosure. In some embodiments, example computing environment 100 may include client devices 105A and 105B, data repository 140, network 110, and deployment platform 120. The components of example computing environment 100 may be contained within a single physical or virtual computing device, or multiple physical or virtual computing devices. The component of example computing environment 100 may be communicatively couple to each other locally, or they may be distributed remotely across multiple computing devices, such as in a cloud computing environment.

Client devices 105A and 105B include a computing device such as a table, laptop, desktop, smart phone, or any other suitable computing system/device. Users, such as a vendor, a client, etc. may interact with the other components of the example computing environment 100 through client devices 105A and 105B (collectively referred to as “client devices 105”). In some embodiments, there may be more, or fewer, client devices 105. For example, a vendor's sales and/or technical staff may control multiple client devices 105, while allowing a potential client to use another, or multiple other, client devices 105.

Network 110 may be implemented using any number of any suitable communications media. For example, the network 110 may be a wide area network (WAN), a local area network (LAN), an internet, or an intranet. For example, client devices 105, data repository 140, and deployment platform 120 may communicate using a local area network (LAN), one or more hardwire connections, a wireless link or router, or an intranet.

Deployment platform 120 may be implemented within a cloud computing environment. For example, deployment platform 120 may be a type of software as a service. In some embodiments, deployment platform 120 may include machine learning zero model 125 and artificial data generator 130. Artificial data generator 130 may include a random number generator 133, a distribution controller 135, and a target values extractor 137.

In some embodiments, a client may provide a target description using one or more client devices 105. The target description may be passed to the data platform 120, which may direct the target description to the artificial data generator 130. In some embodiments, target values extractor 137 may analyze the target description and identify the attributes/features in the description (e.g., the attributes/features of an optimal datapoint). In other embodiments, this information may be provided directly by a client or a member of a vendor's technical or sales staff, for example. In some embodiments, information regarding the type of target (e.g., classification information, regression information, etc.) may also be provided.

Random number generator (RNG) 133 may generate random, or semi-random (e.g., random values falling within parameters established from the target description) values for the set of artificial data that will be used to train the machine learning zero model 125.

Distribution controller 135 may control/screen a set of artificial data to ensure the distribution of datapoints conforms to normal and/or anticipated distribution patterns. In some embodiments, the distribution information may be supplied by the client, randomly generated by RNG 133, or gathered from information available in data repository 140.

Data repository 140 may include data sources that may be used to enhance the generation and/or distribution of the set of artificial data. For example, data repository may include census information, population density information, demographic statistics, etc. In some embodiments, data repository 140 represents a plurality of separate data sources, such as publicly accessible databases distributed across the Internet.

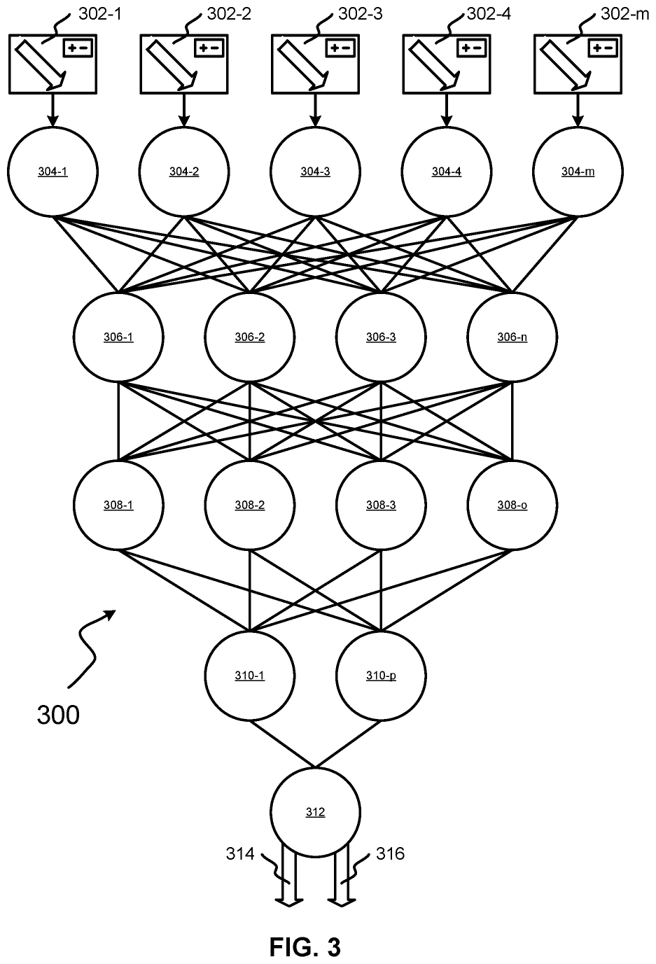

Machine learning zero model 125 may include one or more neural networks, such as the neural network described in FIG. 3 and may be trained using the set of artificial data generated by artificial data generator 130. In this way, machine learning zero model 125 may be customized to provide a demonstration for solving a client-specific problem without compromising a client's potentially sensitive or confidential training data.

Once machine learning zero model 125 is trained, a set of demonstration data and/or authentic data may be submitted by using one or more client devices 105, processed by the machine learning zero model 125, and a user (e.g., a client or vendor agent) may be notified of the results.

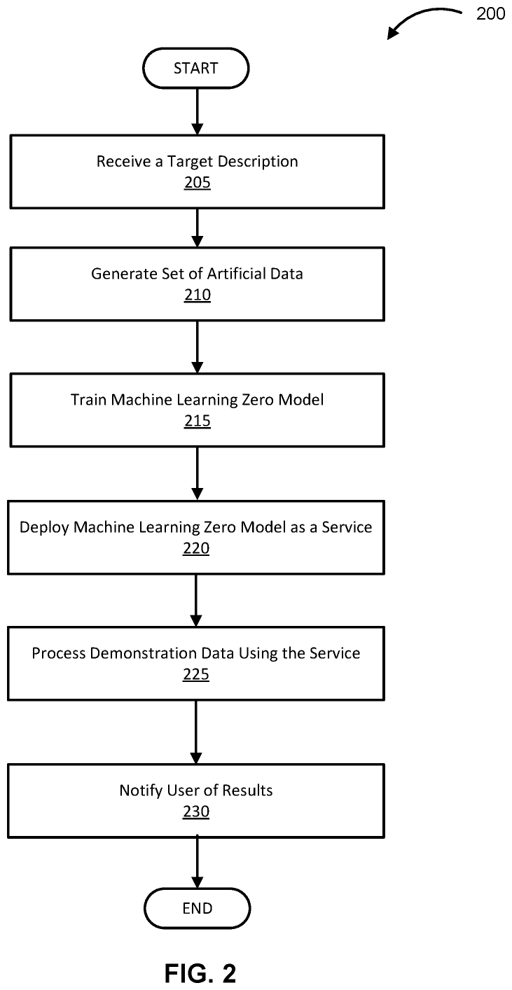

Referring now to FIG. 2, illustrated is a flowchart of a method 200 for deploying a machine learning zero model (e.g., machine learning zero model 125 of FIG. 1), in accordance with embodiments of the present disclosure. Method 200 may begin at 205, where a target description is received, as described herein. In some embodiments, the target description may be a characterization of the problem a client or other entity wishes to solve/automate/anticipate using a machine learning model.

In some embodiments, a target description may be submitted in JavaScript Object Notation (JSON). An example of a multiclass classification target description in JSON format may include:

business_case: {
“problem_type”: “multiclass_classification”
“target”:{
“name”: “Engagement_Rate”,
“samples” : [“Low Engagement”, “No Engagement”, “High
Engagement”],
}
“features”:[
{
“name”: [“Age”],
“range”: {
“lower_limit”: 18,
“upper_limit”: 90
}
},
{
“name”: [“Gender”],
“samples”: [“male”, “female”]
},
}

At 210, a set of artificial data is generated, as described herein. In some embodiments, the received target description may be used to inform the generation of the set of artificial data, as described herein. For example, the target description may provide information regarding a target demographic.

At 215, the machine learning zero model is trained using the set of artificial data, as described herein. In some embodiments, this may include adjusting one or more weights and/or biases of the edges of a neural network until the machine learning model outputs a desired result or set of results. In some embodiments, the set of artificial data may include a datapoint generated using an optimal datapoint generated directly from the target description. This optimal datapoint may represent a “best case” datapoint, for example, which may ensure that at least one datapoint interacts with every node and/or edge of the neural network. In some embodiments, the training may be executed using scikit-learn framework; logistic/linear regression estimators may be used.

At 220, the machine learning zero model is deployed as a service, as described herein. In some embodiments, deployment may include making the machine learning zero model available for interaction through a webservice portal in a cloud computing environment.

At 225, the service may be used to submit a set of demonstration data or authentic data for processing by the trained machine learning zero model, as described herein. The output/results of 225 may be stored in a data repository.

At 230, a user is notified of the results, as described herein. In some embodiments, the user may be notified directly through a user interface. The results may be presented textually, as an array of values, or in a more comprehensive medium, such as with interactive charts.

FIG. 3 depicts an example neural network 300 that may be specialized to implement a machine learning zero model, in accordance with embodiments of the present disclosure. In embodiments, neural network 300 may be a classifier-type neural network. Neural network 300 may be part of a larger neural network. For example, neural network 300 may be nested within a single, larger neural network, connected to several other neural networks, or connected to several other neural networks as part of an overall aggregate neural network.

Inputs 302-1 through 302-m represent the inputs to neural network 300. In this embodiment, 302-1 through 302-m do not represent different inputs. Rather, 302-1 through 302-m represent the same input that is sent to each first-layer neuron (neurons 304-1 through 304-m) in neural network 300. In some embodiments, the number of inputs 302-1 through 302-m (i.e., the number represented by m) may equal (and thus be determined by) the number of first-layer neurons in the network. In other embodiments, neural network 300 may incorporate 1 or more bias neurons in the first layer, in which case the number of inputs 302-1 through 302-m may equal the number of first-layer neurons in the network minus the number of first-layer bias neurons. In some embodiments, a single input (e.g., input 302-1) may be input into the neural network. In such an embodiment, the first layer of the neural network may comprise a single neuron, which may propagate the input to the second layer of neurons.

Inputs 302-1 through 302-m may comprise one or more samples of classifiable data. For example, inputs 302-1 through 302-m may comprise 10 samples of classifiable data. In other embodiments, not all samples of classifiable data may be input into neural network 300.

Neural network 300 may comprise 5 layers of neurons (referred to as layers 304, 306, 308, 310, and 312, respectively corresponding to illustrated nodes 304-1 to 304-m, nodes 306-1 to 306-n, nodes 308-1 to 308-o, nodes 310-1 to 310-p, and node 312). In some embodiments, neural network 300 may have more than 5 layers or fewer than 5 layers. These 5 layers may each be comprised of the same number of neurons as any other layer, more neurons than any other layer, fewer neurons than any other layer, or more neurons than some layers and fewer neurons than other layers. In this embodiment, layer 312 is treated as the output layer. Layer 312 outputs a probability that a target event will occur and contains only one neuron (neuron 312). In other embodiments, layer 312 may contain more than 1 neuron. In this illustration no bias neurons are shown in neural network 300. However, in some embodiments each layer in neural network 300 may contain one or more bias neurons.

Layers 304-312 may each comprise an activation function. The activation function utilized may be, for example, a rectified linear unit (ReLU) function, a SoftPlus function, a Soft step function, or others. Each layer may use the same activation function, but may also transform the input or output of the layer independently of or dependent upon the activation function. For example, layer 304 may be a “dropout” layer, which may process the input of the previous layer (here, the inputs) with some neurons removed from processing. This may help to average the data, and can prevent overspecialization of a neural network to one set of data or several sets of similar data. Dropout layers may also help to prepare the data for “dense” layers. Layer 306, for example, may be a dense layer. In this example, the dense layer may process and reduce the dimensions of the feature vector (e.g., the vector portion of inputs 302-1 through 302-m) to eliminate data that is not contributing to the prediction. As a further example, layer 308 may be a “batch normalization” layer. Batch normalization may be used to normalize the outputs of the batch-normalization layer to accelerate learning in the neural network. Layer 310 may be any of a dropout, hidden, or batch-normalization layer. Note that these layers are examples. In other embodiments, any of layers 304 through 310 may be any of dropout, hidden, or batch-normalization layers. This is also true in embodiments with more layers than are illustrated here, or fewer layers.

Layer 312 is the output layer. In this embodiment, neuron 312 produces outputs 314 and 316. Outputs 314 and 316 represent complementary probabilities that a target event will or will not occur. For example, output 314 may represent the probability that a target event will occur, and output 316 may represent the probability that a target event will not occur. In some embodiments, outputs 314 and 316 may each be between 0.0 and 1.0, and may add up to 1.0. In such embodiments, a probability of 1.0 may represent a projected absolute certainty (e.g., if output 314 were 1.0, the projected chance that the target event would occur would be 100%, whereas if output 316 were 1.0, the projected chance that the target event would not occur would be 100%).

In embodiments, FIG. 3 illustrates an example probability-generator neural network with one pattern-recognizer pathway (e.g., a pathway of neurons that processes one set of inputs and analyzes those inputs based on recognized patterns, and produces one set of outputs). However, some embodiments may incorporate a probability-generator neural network that may comprise multiple pattern-recognizer pathways and multiple sets of inputs. In some of these embodiments, the multiple pattern-recognizer pathways may be separate throughout the first several layers of neurons, but may merge with another pattern-recognizer pathway after several layers. In such embodiments, the multiple inputs may merge as well (e.g., several smaller vectors may merge to create one vector). This merger may increase the ability to identify correlations in the patterns identified among different inputs, as well as eliminate data that does not appear to be relevant.

In embodiments, neural network 300 may be trained/adjusted (e.g., biases and weights among nodes may be calibrated) by inputting feedback and/or input from a user to correct/force the neural network to arrive at an expected output. In embodiments, the impact of the feedback on the weights and biases may lessen over time, in order to correct for inconsistencies among user(s) and/or datasets. In embodiments, the degradation of the impact may be implemented using a half-life (e.g., the impact degrades by 50% for every time interval of X that has passed) or similar model (e.g., a quarter-life, three-quarter-life, etc.).

It is to be understood that although this disclosure includes a detailed description on cloud computing, implementation of the teachings recited herein are not limited to a cloud computing environment. Rather, some embodiments of the present invention are capable of being implemented in conjunction with any other type of computing environment now known or later developed.

Cloud computing is a model of service deliver for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

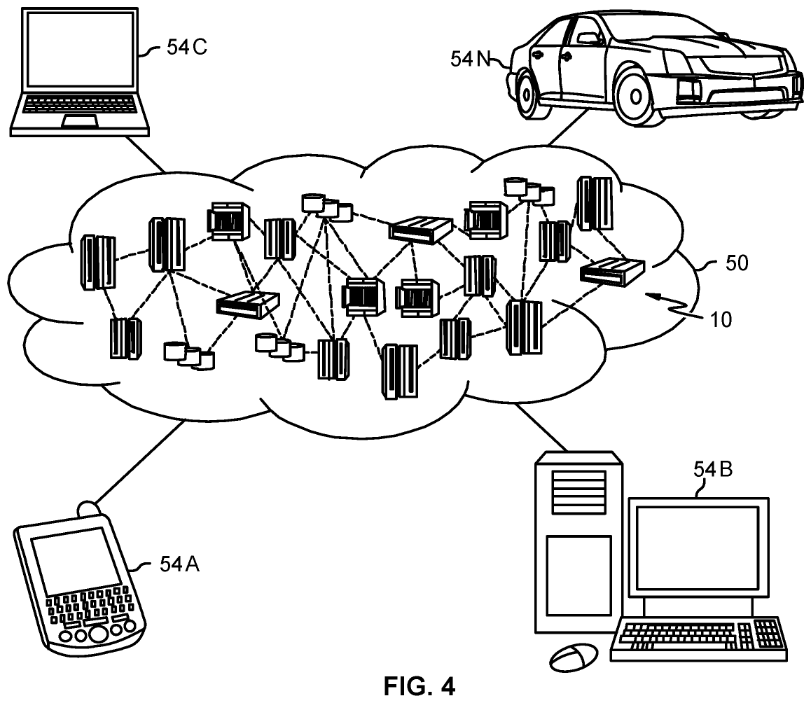

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and some embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and customizing machine learning demonstrations 96.

Referring now to FIG. 6, shown is a high-level block diagram of an example computer system 601 that may be configured to perform various aspects of the present disclosure, including, for example, method 200, described in FIG. 2. The example computer system 601 may be used in implementing one or more of the methods or modules, and any related functions or operations, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 614, an I/O (Input/Output) device interface 616, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may comprise one or more levels of on-board cache.

In some embodiments, the memory subsystem 604 may comprise a random-access semiconductor memory, storage device, or storage medium (either volatile or non-volatile) for storing data and programs. In some embodiments, the memory subsystem 604 may represent the entire virtual memory of the computer system 601, and may also include the virtual memory of other computer systems coupled to the computer system 601 or connected via a network. The memory subsystem 604 may be conceptually a single monolithic entity, but, in some embodiments, the memory subsystem 604 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 604 may contain elements for control and flow of memory used by the CPU 602. This may include a memory controller 605.

Although the memory bus 603 is shown in FIG. 6 as a single bus structure providing a direct communication path among the CPUs 602, the memory subsystem 604, and the I/O bus interface 610, the memory bus 603 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, mobile device, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for deploying a machine learning zero model, the method comprising:
receiving a target description;
generating, based on the target description, a set of artificial data;
training the machine learning zero model using the set of artificial data;
deploying the machine learning zero model as a service;
processing a set of demonstration data using the service; and
notifying a user of the results of the processing.

2. The method of claim 1, wherein the target description includes at least one input feature.

3. The method of claim 2, wherein the input feature includes a set of categorical features, and each categorical feature within the set is associated with a range of values.

4. The method of claim 2, wherein the set of artificial data includes at least one thousand artificial data records.

5. The method of claim 4, wherein the set of artificial data includes at least one artificial data record containing values associated with the target description.

6. The method of claim 5, wherein training the machine learning zero model includes adjusting a weight and a bias of at least one edge of a neural network.

7. The method of claim 6, wherein deploying the machine learning zero model as a service enables unilaterally provisioning computing capabilities in a cloud environment.

8. A computer program product for deploying a machine learning zero model, the computer program product comprising a computer readable storage medium having program instructions embodied therewith, the program instructions executable by a device to cause the device to:
receive a target description;
generate, based on the target description, a set of artificial data;
train the machine learning zero model using the set of artificial data;
deploy the machine learning zero model as a service;
process a set of demonstration data using the service; and
notify a user of the results of the processing.

9. The computer program product of claim 8, wherein the target description includes at least one input feature.

10. The computer program product of claim 9, wherein the input feature includes a set of categorical features, and each categorical feature within the set is associated with a range of values.

11. The computer program product of claim 9, wherein the set of artificial data includes at least one thousand artificial data records.

12. The computer program product of claim 11, wherein the set of artificial data includes at least one artificial data record containing values associated with the target description.

13. The computer program product of claim 12, wherein training the machine learning zero model includes adjusting a weight and a bias of at least one edge of a neural network.

14. The computer program product of claim 13, wherein deploying the machine learning zero model as a service enables unilaterally provisioning computing capabilities in a cloud environment.

15. A system for deploying a machine learning zero model, comprising:
a memory with program instructions included thereon; and
a processor in communication with the memory, wherein the program instructions cause the processor to:
receive a target description;
generate, based on the target description, a set of artificial data;
train the machine learning zero model using the set of artificial data;
deploy the machine learning zero model as a service;
process a set of demonstration data using the service; and
notify a user of the results of the processing.

16. The system of claim 15, wherein the target description includes at least one input feature.

17. The system of claim 16, wherein the input feature includes a set of categorical features, and each categorical feature within the set is associated with a range of values.

18. The system of claim 16, wherein the set of artificial data includes at least one thousand artificial data records.

19. The system of claim 18, wherein the set of artificial data includes at least one artificial data record containing values associated with the target description.

20. The system of claim 19, wherein training the machine learning zero model includes adjusting a weight and a bias of at least one edge of a neural network.
